(19) United States
(12) Patent Application Publication
(10) Pub. No.: US 2004/0081821 A1
(43) Pub. Date: Apr. 29, 2004

(54) Film and protecting sheet comprising said film for display window of portable-type information terminal

(75) Inventors: Kazuhiro Yokoo, Niihama-shi (JP); Koji Koyama, Niihama-shi (JP); Yoshimi Nakagawa, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/671,766

(22) Filed: Sep. 29, 2003

(30) Foreign Application Priority Data
Oct. 28, 2002 (JP) 2002-312275

(51) Int. Cl. B32B 5/16

(52) U.S. Cl. 428/326; 428/323

(57) ABSTRACT

There are provided (1) a film, which comprises a methacryl resin layer containing a dispersed rubber particle, wherein at least one surface of said film has a cured layer containing a curable coating, and said film has thickness of 100 to 1800 μm; and (2) a protecting sheet for a display window of a portable-type information terminal, which comprises said film.

### FIELD OF THE INVENTION

The present invention relates to a film having superior physical properties such as a scratch resistance; and a protecting sheet for a display window of a portable-type information terminal, which comprises said film.

### BACKGROUND OF THE INVENTION

In recent years, portable-type phones such as a portable phone and a personal handy-phone system (PHS) have been widely popularized as portable-type information terminals having not merely a function for transmitting a voice but also a function for displaying character information and image information, together with spread of the Internet. Representative forms of the portable phones are shown in FIGS. 1 to 3 by oblique drawings. Each portable phone has some parts such as a display window 1, an operation button part 3 and an antenna 4. The portable phone shown in FIG. 1 has a display part 2 containing a display window 1, which part 2 is folded when it is out of use, thereby covering an operation button part 3. FIG. 2 shows the most popular portable phone having no particular covering mechanism. The portable phone shown in FIG. 3 has a cap 5, which covers an operation button part 3 when it is out of use.

In addition to such portable-type phones, a personal digital assistant (PDA: referred to as “portable information terminal” in Japan) is also widely used, which has both the Internet function and an electronic mail function as well as an address book function. In the present specification, such a portable phone, PHS and PDA are called correctively as a “portable-type information terminal”. Namely, the term “portable-type information terminal” used in the present specification calls correctively an information terminal having such a size that a man or women can carry it with him or her, and having a window to show character and image information.

In these portable-type information terminals, character information and image information are displayed by a method such as a liquid crystal display method and an EL (electroluminescence) display method, and a protecting sheet comprising a transparent resin is generally used for a display window thereof. Among them, a methacryl-based resin made sheet is widely used because of its superior transparency. Also, said sheet generally has a scratch resistance layer (hard coat layer) of a crosslinked layer in order to protect its surface from scratch. For example, JP-A 2002-6764 (corresponding to US-A1-2002/0021393) discloses (1) a material for a display window of a portable phone, a surface of which material has a reflection preventing layer, and (2) that said reflection preventing layer is preferably laminated on a resin substrate having a hard coat layer on its surface.

Further, since these portable-type information terminals (particularly portable-type phones such as a portable phone and PHS) have become lighter, and since compact and slim designs thereof have been popularized, a transparent resin sheet used as a protect sheet for a display window is required to have a thin thickness.

On the other hand, regarding the methacryl-based resin, for example, JP-A 10-279766 (corresponding to U.S. Pat. No. 6,147,162)) discloses a process comprising the steps of dispersing a rubber particle in said resin, and then making a film or a sheet thereof. Said patent literature exemplifies a rubber particle disclosed in JP-B 55-27576 (corresponding to U.S. Pat. No. 3,793,402) as said rubber particle.

### SUMMARY OF THE INVENTION

While a protecting sheet for a display window of a portable-type information terminal is required to have strength against an impact from an outside because said protecting sheet is used as a material to protect said display window such as a liquid crystal display window and an EL display window, the thinner thickness said protecting sheet has, the lower impact strength said sheet has. Particularly, while a folding portable phone as shown in FIG. 1 is highly popularized in recent years, it is feared that (1) rising parts of operating buttons located in its central part (specifically a rising part of a No. 5 button) are contacted with a display window, and (2) a protecting sheet thereof is broken when receiving an impact such as a falling impact, because the folded display window of said folding portable phone is opposed to its operating buttons.

Accordingly, an object of the present invention is to provide a film having a superior scratch resistance as well as transparency, impact resistance and thinness. Another object of the present invention is to provide a protecting sheet, using said film, for a display window of a portable-type information terminal, which protecting sheet has superior transparency and scratch resistance, and shows a high impact resistance even though it is a thin sheet.

Under these circumstances, the present inventers have undertaken extensive studies to develop a resin film having a high impact resistance even though it is a thin film, and also having a superior scratch resistance, and, as a result, the present inventers have found that a scratch resistance-carrying resin film having transparency, impact resistance and thinness can be obtained by making a scratch resistance-carrying layer on a specific film, and thereby the present invention has been obtained.

The present invention is a film, which comprises a methacryl resin layer containing a dispersed rubber particle, wherein at least one surface of said film has a cured layer containing a curable coating, and said film has thickness of 100 to 1800 μm. Also, the present invention is a protecting sheet comprising said film for a display window of a portable-type information terminal.

### BRIEF DESCRIPTION OF THE DRAWINGS

FIG. 1 is an oblique drawing, which shows an example of folding portable phones.

FIG. 2 is an oblique drawing, which shows another example of portable phones.

FIG. 3 is an oblique drawing, which shows a further example of portable phones.

In these Figures, the numeral 1 denotes a display window; the numeral 2 denotes a display part; the numeral 3 denotes an operation button part; the numeral 4 denotes an antenna; and the numeral 5 denotes a cap.

### DETAILED DESCRIPTION OF THE INVENTION

The methacryl resin in the present invention means a resin containing a methyl methacrylate unit in an amount of 50 to 100% by weight. In the present invention, a monomer unit such as the above-mentioned methyl methacrylate unit means a polymerized monomer unit. Examples of the methacryl resin are a homopolymer of methyl methacrylate and a copolymer thereof with at least one other copolymerizable comonomer. Examples of said comonomer are an acrylic ester such as methyl acrylate and butyl acrylate; an aromatic vinyl compound such as styrene; and a vinyl cyano compound such as acrylonitrile. Although a content of a comonomer unit contained in the above-mentioned copolymer is not limited, a content of an acrylic ester unit is usually about 0.1 to about 10% by weight, and a content of an aromatic vinyl compound unit such as a styrene unit is relatively large, usually about 10 to about 50% by weight, in order to control an moisture absorption, wherein a total amount of the methacryl resin is 100% by weight.

The methacryl resin can be produced by a conventional method such as a suspension polymerization method, an emulsion polymerization method and a bulk polymerization method. It is preferable to use a chain transfer agent in said polymerization in order to obtain a preferable viscosity for making a film. Examples of the chain transfer agent are various known compounds such as mercaptanes (for example, dodecyl mercaptan and octyl mercaptan). An amount of the chain transfer agent used may be suitably determined depending upon a kind and a composition of monomers, and a kind of the chain transfer agent used. Said amount is generally 0.01 to 5% by weight per a total amount of monomers.

Examples of the rubber particle in the present invention are an acryl rubber particle containing an acrylic ester unit in an amount of 50 to 100% by weight, wherein a total amount of the acryl rubber particle is 100% by weight; a butadiene rubber particle containing a butadiene unit in an amount of 50 to 100% by weight, wherein a total amount of the butadiene rubber particle is 100% by weight; and a styrene-butadiene rubber particle containing a styrene unit and a butadiene unit in their total amount of 50 to 100% by weight, wherein a total amount of the styrene-butadiene rubber particle is 100% by weight. Among them, the acryl rubber particle is preferable from a viewpoint of a balance among physical properties of an obtained film such as surface hardness, weather ability and an impact resistance. Examples of the acryl rubber particle are those known in the art, for example, a rubber particle having a single layer structure, which comprises an elastic polymer containing an alkyl acrylate unit such as a butyl acrylate unit as a main monomer unit; and a rubber particle having a multilayer structure, which comprises (1) an inner layer containing a rigid polymer having a methyl methacrylate unit as a main monomer unit, and (2) an outer layer containing an elastic polymer having an alkyl acrylate unit such as a butyl acrylate unit as a main monomer unit. In general, said elastic polymer contains a small amount of a crosslinkable multifunctional comonomer unit.

Further, there can also be favorably used a rubber particle having an outermost layer around an elastic polymer, which layer comprises a rigid polymer containing a methyl methacrylate unit as a main monomer unit. Examples thereof are a rubber particle having a two-layer structure, which comprises (1) an inner layer containing an elastic copolymer having an alkyl acrylate unit such as a butyl acrylate unit as a main monomer unit, and (2) an outer layer containing a rigid polymer having a methyl methacrylate unit as a main monomer unit; and a rubber particle having a three-layer structure, which comprises (1) an inner layer containing a rigid polymer having a methyl methacrylate unit as a main monomer unit, (2) an interlayer containing an elastic polymer having an alkyl acrylate unit such as a butyl acrylate unit as a main monomer unit, and (3) an outermost layer containing a rigid polymer having a methyl methacrylate unit as a main monomer unit. Said rubber particles having a multilayer structure are disclosed, for example, in the above-mentioned JP-B 55-27576 (corresponding to U.S. Pat. No. 3,793,402). Particularly, the above-mentioned rubber particle having a three-layer structure is preferable, and among them, a rubber particle disclosed in Example 3 of said patent literature is more preferable.

An average particle diameter of the rubber particle can be suitably selected depending upon its kind, and it is particularly preferably 0.1 to 0.4 μm in order to obtain a film having a high impact resistance, superior surface hardness and an even surface. When said average particle diameter is smaller than 0.1 μm, surface hardness thereof may be lowered, and also an obtained film is apt to be brittle. When said average particle diameter is larger than 0.4 μm, a film not having an even surface is apt to be obtained. A rubber particle having an average particle diameter of 0.1 to 0.4 μm can generally be produced by an emulsion polymerization method. Said average particle diameter can be controlled to a desired value by regulating an amount of an emulsifier added, and an amount of monomers supplied in said emulsion polymerization method.

The above-mentioned average particle diameter is measured by a method comprising the steps of:

(1) dying a section of a film containing a rubber particle with ruthenium oxide, wherein only the rubber particle is dyed, and a methacryl resin is not dyed,

(2) taking an electron microscope photograph of the dyed rubber particle, which has a nearly circle shape,

(3) measuring respective particle diameters of some rubber particles (for example, 100 rubber particles) optionally selected from said photograph, and

(4) naming an average value of said respective particle diameters by an average particle diameter.

The methacryl resin containing a dispersed rubber particle can be produced by dispersing preferably 5 to 50 parts by weight of a rubber particle in preferably 50 to 95 parts by weight of a methacryl resin. When an amount of the rubber particle is less than 5 parts by weight, it may be difficult to make a film, and an obtained film is apt to be brittle. When an amount of the rubber particle is more than 50 parts by weight, its heat resistance and rigidity are apt to be lowered.

When dispersing the rubber particle, various additives such as ultraviolet absorbers, organic-based dyes, pigments, inorganic-based coloring matters, antioxidants, antistatic agents and surfactants may be blended, if necessary.

The methacryl resin layer containing a dispersed rubber particle in the present invention can be produced by making a film of a methacryl resin containing a dispersed rubber particle. Examples of a method for producing said film (single layer film) are various methods known in the art such as a melt casting method, a melt extruding method (for example, a T-die method and an inflation method) and a calender method. Among them, in order to obtain a film having good surface properties, preferred is a method comprising the steps of (i) melt-extruding a methacryl resin containing a dispersed rubber particle through a T-die to obtain a film-like product, and then (ii) making a film by contacting at least one surface of said film-like product with a roll or a belt. Particularly, in order to obtain a film having an improved surface evenness and surface gloss, preferred is a method comprising the steps of (i) melt-extruding a methacryl resin containing a dispersed rubber particle to obtain a film-like product, and then (ii) making a film by contacting both surfaces of said film-like product with a surface of a roll or a surface of a belt. Said roll or belt is preferably a metal-made roll or belt. A preferable roll is that having a mirror-like surface. Since so obtained film has flexibiliy, it is possible to wind said film in a roll-like shape, and therefore, it handles easily.

The film in the present invention (which does not yet have a cured layer containing a curable coating) may be a multilayer film such as a two layer film and a three layer film, which is obtained by laminating a methacryl resin layer containing no rubber particle on one surface or both surfaces of the above-mentioned single layer film. Said lamination of a methacryl resin layer containing no rubber particle can enhance surface hardness of the film itself. Thickness of the layer containing a rubber particle is preferably 50 to 96%, and more preferably 60 to 96% based on a total thickness of the film. When said thickness is less than 50%, an impact resistance of the film may be lowered. In order to produce such a multilayer film, there can be used, for example, a known multilayer extruder having (i) multiple extruders, and (ii) a mechanism such as a multi-manifold method and a feed block method for laminating a resin extruded from said multiple extruders.

Examples of a method for producing the film (which does not yet have a cured layer containing a curable coating) in the present invention are:

(1) a method comprising the step of making a film of a methacryl resin containing a dispersed rubber particle using an extruder equipped with a T-die,

(2) a method comprising the step of cast-polymerizing a polymerizable monomer mixture containing (I) the above-mentioned monomer(s), (ii) a known thermally polymerizable radical initiator such as azobisisobutyronitriile and dilauroyl peroxide, and (iii) a rubber particle in a glass cell or a metal-made cell having a controlled cell thickness in order to obtain a film having a desired thickness, and

(3) a method comprising the step of cast-polymerizing continuously a polymerizable monomer mixture mentioned in the above method (2) using a continuous cast-polymerization apparatus having a metal-made continuous belt.

The above-mentioned polymerizable monomer mixture may contain additives such as a viscosity controller (for example, a methacryl resin obtained by partially polymerizing methyl methacrylate), chain transfer agents (for example, mercaptanes), ultraviolet absorbers and release agents.

The film in accordance with the present invention has thickness of 100 to 1800 μm, and preferably 300 to 1500 μm. When said thickness is less than 100 μm, strength and rigidity of the film are insufficient for use such as a protecting sheet for a display window of a portable-type information terminal. When said thickness is more than 1800 μm, the obtained film may not be suitable for designing a portable-type information terminal.

The film in accordance with the present invention may have either an even surface or a finely rough surface. When applying the film to a protecting sheet for a display window of a portable-type information terminal, said film has a plane shape or a curved surface-carrying shape depending upon a surface shape of said display window.

An example of a method for producing the film in accordance with the present invention is a method comprising the steps of (i) applying a curable coating to at least one surface of the above-mentioned film (which does not yet have a cured layer containing a curable coating), and then (ii) curing the applied coating. When using a film, which has a cured layer containing a curable coating on its one surface, as a protecting sheet for a display window of a portable-type information terminal, said film is used so as to turn said cured layer outward. When the above-mentioned two layer film has said cured layer on its one surface, said cured layer may be made on either surface of said two layer film. When thinking much of an impact resistance of a protecting sheet for a display window of a portable-type information terminal, a cured layer may be made on a rubber particle-containing layer to obtained a film, and said film may be used so as to turn said cured layer outward; and when thinking much of hardness thereof, a cured layer may be made on a rubber particle-non-containing layer to obtained a film, and said film may be used so as to turn said cured layer outward. In general, it is preferable to make a cured layer on a rubber particle-non-containing hard layer to obtained a film, and is preferable to use said film such that said cured layer is turned outward.

The curable coating in the present invention means a coating containing a scratch resistance-giving curable compound as a main component. Said curable compound may be combined with, for example, a solvent, an electroconductive inorganic particle and a curing catalyst.

There can be exemplified, as the curable compound giving a scratch resistance, an acrylate, a urethane acrylate, an epoxy acrylate, an epoxy acrylate modified with a carboxyl group, a polyester acrylate, a copolymerization-based acrylate, an alicyclic-type epoxy resin, a glycidyl ether epoxy resin, a vinyl ether compound, and an oxetane compound. Among them, examples of the curable compound giving a high scratch resistance are a radically polymerizable curing compound such as a polyfunctional acrylate-based compound, a polyfunctional urethane acrylate-based compound and a polyfunctional epoxy acrylate-based compound; and a thermally polymerizable curable compound. These curable compounds are cured by radiating, for example, an electron beam, a radioactive ray or an ultraviolet light, or by heating. Hereinafter, said beam, ray and light are correctively referred to as “beam”. These curable compounds may be used singly, respectively, or used in combination of two or more thereof.

Among them, a preferable curable compound is a compound having at least tree (meth)acryloyloxy groups in its molecule. Here, “(meth)acryloyloxy group” means an acryloyloxy group or a methacryloyloxy group. A term “(meth)” used for other compounds such as methyl (meth)acrylate and (meth)acrylic acid in the present invention has a similar meaning thereto.

Examples of the curable compound having at least tree (meth)acryloyloxy groups in its molecule are a poly(meth)acrylate of an alcohol containing at least three hydroxyl groups such as trimethylol propane tri(meth)acrylate, trimethylol ethane tri(meth)acrylate, glycerin tri(meth)acrylate, pentaglycerol tri(meth)acrylate, pentaerythritol tri- or tetra-(meth)acrylate, dipentaerythritol tri-, tetra-, penta- or hexa-(meth)acrylate and tripentaerythritol tetra-, penta-, hexa- or hepta-(meth)acrylate; aurethane (meth)acrylate having at least three (meth)acryloyloxy groups in its molecule, which compound can be obtained by reacting a compound having at least two isocyanate groups in its molecule with a (meth)acrylate monomer having a hydroxyl group in the molar ratio of an amount of the hydroxyl group to an amount of the isocyanate group of 1 or more, such as a 3 to 6 functional urethane (meth)acrylate obtained by reacting a diisocyanate with pentaerythritol tri(meth)acrylate; and a tri(meth)acrylate of tris(2-hydroxyethyl)isocyanuric acid. Each of these compounds may be used as a monomer or an oligomer thereof such as a dimer and a trimer.

The curable compound having at least tree (meth)acryloyloxy groups in its molecule may be a commercially available one. Examples thereof are “NK HARD M101” (urethane acrylate-based compound, produced by Shin-Nakamura Chemical Co., Ltd.), “NK ESTER A-TMM-3L” (pentaerythritol triacrylate, produced by Shin-Nakamura Chemical Co., Ltd.), “NKESTERA-TMMT” (pentaerythritol tetraacrylate, produced by Shin-Nakamura Chemical Co., Ltd.), “NK ESTER A-9530” (dipentaerythritol hexaacrylate, produced by Shin-Nakamura Chemical Co., Ltd.), “KAYARAD DPCA” (dipentaerythritol hexaacrylate, produced by Nippon Kayaku Co., Ltd.), “NOPCOCURE 200” series (produced by San Nopco Ltd., and “UNIDIC” series (produced by Dainippon Ink & Chemicals, Inc.).

A content of the compound having at least tree (meth)acryloyloxy groups in its molecule contained in the curable coating is 50 parts by weight or more, and preferably 60 parts by weight or more per 100 parts by weight of a solid part contained in said curable coating. When said content is less than 50 parts by weight, a surface hardness may be insufficient.

Further examples of the curable compound are mixtures such as malonic acid/trimethylol ethane/(meth)acrylic acid, malonic acid/trimethylol propane/(meth)acrylic acid, malonic acid/glycerin/(meth)acrylic acid, malonic acid/pentaerythritol/(meth)acrylic acid, succinic acid/trimethylol ethane/(meth)acrylic acid, succinic acid/trimethylol propane/(meth)acrylic acid, succinic acid/glycerin/(meth)acrylic acid, succinic acid/pentaerythritol/(meth)acrylic acid, adipic acid/trimethylol ethane/(meth)acrylic acid, adipic acid/trimethylol propane/(meth)acrylic acid, adipic acid/glycerin/(meth)acrylic acid, adipic acid/pentaerythritol/(meth)acrylic acid, glutaric acid/trimethylol ethane/(meth)acrylic acid, glutaric acid/trimethylol propane/(meth)acrylic acid, glutaric acid/glycerin/(meth)acrylic acid, glutaric acid/pentaerythritol/(meth)acrylic acid, sebacic acid/trimethylol ethane/(meth)acrylic acid, sebacic acid/trimethylol propane/(meth)acrylic acid, sebacic acid/glycerin/(meth)acrylic acid, sebacic acid/pentaerythritol/(meth)acrylic acid, fumaric acid/trimethylol ethane/(meth)acrylic acid, fumaric acid/trimethylol propene/(meth)acrylic acid, fumaric acid/glycerin/(meth)acrylic acid, fumaric acid/pentaerythritol/(meth)acrylic acid, itaconic acid/trimethylol ethane/(meth)acrylic acid, itaconic acid/trimethylol propene/(meth)acrylic acid, itaconic acid/pentaerythritol/(meth)acrylic acid, maleic anhydride/trimethylol ethane/(meth)acrylic acid, and maleic anhydride/glycerin/(meth) acrylic acid, wherein the expression such as “malonic acid/trimethylol ethane/(meth)acrylic acid” means a mixture of malonic acid, trimethylol ethane and meth)acrylic acid. Each of these mixtures may be combined with the compound having at least tree (meth)acryloyloxy groups in its molecule.

When curing the curable coating with an ultraviolet light, a photopolymerization initiator is used. Examples thereof are benzil; benzophenone and its derivatives; thioxanthones; benzyldimethylketals; α-hydroxyalkylphenones; hydroxyketones; aminoalkylphenones; and acylphosphine oxides. The photopolymerization initiator is added in an amount of generally 0.1 to 5 parts by weight, per 100 parts by weight of the curable compound.

Each of the above-mentioned photopolymerization initiators may be used singly, and most of them may be used in a combined mixture of two or more thereof. The photopolymerization initiator may be a commercially available one. Examples thereof are “IRGACURE 651”, “IRGACURE 184”, “IRGACURE500”, “IRGACURE1000”, “IRGACURE2959”, “DAROCUR1173”, “IRGACURE907”, “IRGACURE369”, “IRGACURE1700”, “IRGACURE1800”, “IRGACURE 819” and “IRGACURE 784”, all of which are sold by Ciba Specialty Chemicals K.K., and “KAYACURE ITX”, “KAYACURE DETX-S”, “KAYACURE BP-100”, “KAYACURE BMS” and “KAYACURE 2-EAQ”, all of which are sold by Nippon Kayaku Co., Ltd.

The curable coating may contain an electroconductive inorganic particle in order to give an antistatic property to a layer. Examples of the electroconductive inorganic particle are tin oxide doped with antimony, tin oxide doped with phosphor, antimony oxide, zinc antimonate, titanium oxide, and ITO (indium tin oxide).

A particle diameter of the electroconductive inorganic particle can be suitably selected depending upon its kind, and said particle diameter is generally not more than 0.5 μm. An average particle diameter of said particle is preferably 0.001 to 0.1 μm, and further preferably 0.001 to 0.05 μm from a viewpoint of a antistatic property and transparency of the layer. When said average particle diameter is more than 0.1 μm, an obtained film has a large haze value, and as a result, its transparency may be lowered. The electroconductive inorganic particle is used in an amount of generally about 2 to about 50 parts by weight, and preferably about 3 to about 20 parts by weight, per 100 parts by weight of the curable compound. When said amount is less than about 2 parts by weight, an antistatic property cannot be improved sufficiently. When said amount is more than about 50 parts by weight, transparency of a cured layer may be lowered.

Examples of a method for producing such an electroconductive inorganic particle are a gas phase decomposition method, a plasma vaporization method, an alkoxide decomposition method, a co-precipitation method and a hydrothermal method. A surface of the electroconductive inorganic particle may be treated with an agent such as nonion-based surfactants, cation-based surfactants, anion-based surfactants, silicone-based coupling agents, and aluminum-based coupling agents.

The curable coating may contain a solvent in order to control physical properties such as viscosity. Particularly, when the curable coating contains an electroconductive inorganic particle, it is preferable to use a solvent in order to disperse said particle. Examples of a process for producing the curable coating using an electroconductive inorganic particle and a solvent are (1) a process comprising the steps of (i) mixing an electroconductive inorganic particle with a solvent to disperse the former in the latter, thereby obtaining a mixture, and then (ii) mixing said mixture with a curable compound; and (2) a process comprising the steps of (i) mixing a curable compound with a solvent to obtaining a mixture, and then (ii) adding an electroconductive inorganic particle to said mixture.

There can be used any solvent capable of dissolving a curable compound, and volatilizing after applying; and when using an electroconductive inorganic particle, there can be used any solvent capable of dispersing said particle. Examples of the solvent are alcohols such as diacetone alcohol, methanol, ethanol, isopropyl alcohol and 1-methoxy-2-propanol; ketones such as acetone and methyl ethyl ketone; aromatic hydrocarbons such as toluene and xylene; esters such as ethyl acetate; and water. An amount of the solvent used is not particularly limited, and said amount can be suitably selected depending upon various conditions such as properties of a curable compound.

The curable coating may contain a leveling agent known in the art. An example thereof is a silicone oil-based leveling agent. Common silicone oil can be used, and specific examples thereof are dimethyl silicone oil, phenylmethyl silicone oil, alkyl.aralkyl-modified silicone oil, fluoro silicone oil, polyether-modified silicone oil, fatty acid ester-modified silicone oil, methyl hydrogen silicone oil, silanol group-containing silicone oil, alkoxy group-containing silicone oil, phenol group-containing silicone oil, methacryl-modified silicone oil, amino-modified silicone oil, carboxylic acid-modified silicone oil, carbinol-modified silicone oil, epoxy-modified silicone oil, mercapto-modified silicone oil, fluorine-modified silicone oil, and polyether-modified silicone oil. The leveling agent may be a commercially available one. Examples thereof are “SH200-100cs”, SH28PA”, “SH29PA”, “SH30PA”, “ST83PA”, “ST80PA”, “ST97PA” and “ST86PA”, all of which sold by Dow Corning Toray Silicone Co., Ltd. Each of these leveling agents may be used singly, respectively, and they also may be used in a combined mixture of two or more thereof. An amount of the leveling agent used is suitably selected depending upon characteristics of a curable coating, and said amount is generally about 0.01 to about 5 parts by weight, per 100 parts by weight of a curable compound.

A further example of a process for producing the film in accordance with the present invention is a process comprising the steps of (1) applying a curable coating to an inner surface of a glass cell, a metal-made cell or a continuous belt-type cell, (2) curing said curable coating to make a cured layer, (3) adding the above-mentioned polymerizable monomer mixture into said cell, and then (4) polymerizing said polymerizable monomer mixture to make a film, and thereby transferring said cured layer onto a surface of said film (hereinafter, referred to as “transfer process”).

Examples of a method for applying a curable coating are known coating methods such as a bar coating method, a microgravure coating method, a roll coating method, a flow coating method, a dip coating method, a spin coating method, a die coating method, and a spray coating method.

Strength and a radiation time of the above-mentioned energy beam are suitably selected depending upon a kind of the curable coating applied. Conditions such as temperature and time required for thermally curing are suitably selected depending upon a kind of a curable coating used, and a preferable temperature is generally not more than 100° C. in order to obtain a film having no defects such as deformation. When using a curable coating containing a solvent, curing may be carried out (i) after the steps of applying the curable coating, and then volatilizing the solvent contained therein, or (ii) simultaneously with said volatilization.

Thickness of a cured layer is preferably about 0.5 to about 50 μm, and further preferably about 1 to about 20 μm. When said thickness is more than about 50 μm, said layer is apt to have crack, and when said thickness is less than about 0.5 μm, a scratch resistance of said layer may be insufficient.

The film in accordance with the present invention can be given an effect to prevent from reflection (1) by treating a surface of said film with a known method such as a coating method, a sputtering method and a vacuum metallizing method, or (2) by laminating a separately produced reflection-preventing film on one or both surfaces of said film.

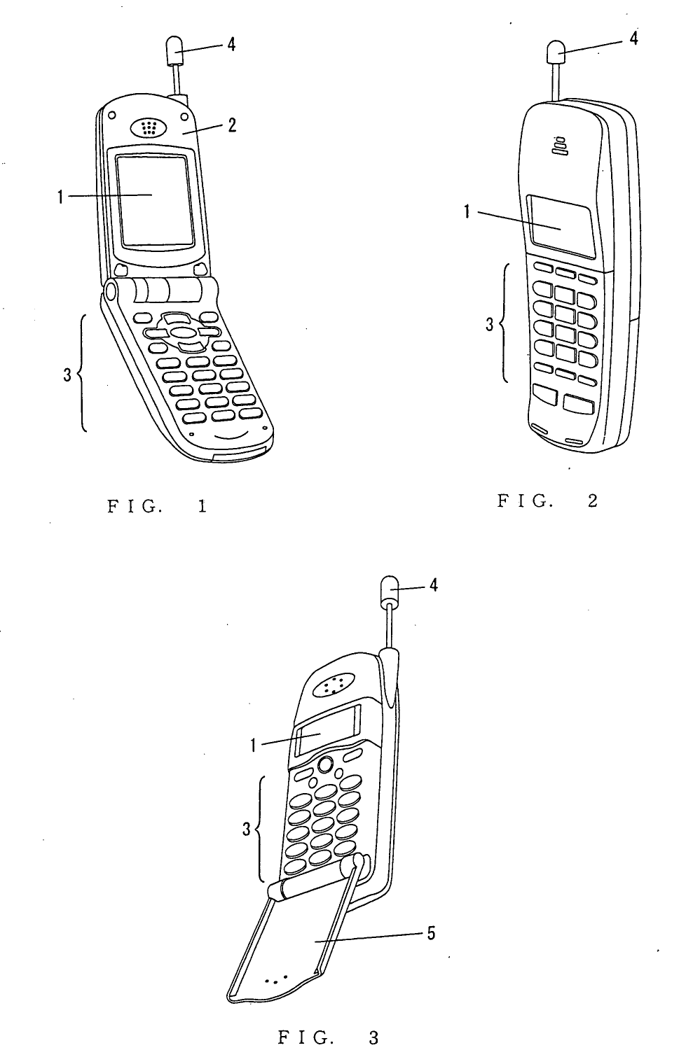

As well as a protecting sheet for a display window of a portable-type information terminal such as a portable phone, the film in accordance with the present invention can be used as various parts in a field required a scratch resistance and transparency, such as a finder part of, for example, a digital camera and a handy-type video camera, and a protecting sheet for a display window of a portable-type game instrument. The film in accordance with the present invention particularly gives an advantageous effect to a protecting sheet for a display window of a portable phone, especially, a portable phone as shown in FIG. 1, wherein a display part 2 containing a display window 1 is folded when it is out of use, thereby covering an operation button part 3.

An example of a process for producing the protecting sheet for a display window of a portable-type information terminal in accordance with the present invention is a process comprising the steps of (1) optionally, printing or punching the film in accordance with the present invention, (2) cutting said film to a desired size, and (3) setting said cut film on a display window of a portable-type information terminal.

### EXAMPLE

The present invention is explained with reference to the following Examples, which do not limit the scope of the present invention.

### Example 1

(A) Preparation of a Methacryl Resin Film Containing a Dispersed Rubber Particle

80 Parts by weight of a methacryl resin pellet and 20 parts by weight of a rubber particle were mixed with a super mixer, and then the obtained mixture was melt kneaded with a double screw extruder, thereby obtaining a pellet. Next, said pellet was extruded though a T-die, using a 65 φ single screw extruder manufactured by Toshiba Machine Co., Ltd., and then the resultant extrudate was cooled such that both surface thereof were completely contacted with a polishing roll, thereby obtaining a film having a thickness of 800 μm. An impact test of said film was carried out according to the following method, and its result is shown in Table 1.

As the above-mentioned methacryl resin pellet, there was used a pellet of a resin obtained by polymerizing a monomer mixture of 98% by weight of methyl methacrylate and 2% by weight of methyl acrylate.

As the above-mentioned rubber particle, there was used a rubber particle having (i) an average particle diameter of 0.2 μm, and (ii) a spherical three layer structure, which rubber particle was made according to Example 3 of JP-B 55-27576 (corresponding to U.S. Pat. No. 3,793,402). Said rubber particle had (i) an innermost layer containing a crosslinked polymer of methyl methacrylate and a small amount of ally methacrylate, (ii) an interlayer containing a soft elastic copolymer of butyl acrylate as a main component, styrene and a small amount of ally methacrylate, and (iii) a outermost layer containing a rigid polymer of methyl methacrylate and a small amount of ethyl acrylate.

(B) Impact Test

It was carried out using a DuPont drop tester manufactured by Yasuda-Seiki Co., Ltd. according to a method comprising the steps of:

(1) placing a sample film without any fixation on a stand having a 250 mm diameter window,

(2) putting a cone, which has a 240 g weight and an extreme point of a 2 mm diameter, on said film corresponding to said window such that said extreme point is contacted with said film,

(3) dropping a 100 g-weight on said cone from 1500 mm height, and

(4) observing whether or not a crack has been made on said sample film.

(C) Preparation of a Film Having a Cured Layer

A cured layer-having film was prepared by a method comprising the steps of (i) applying a curable coating to both surfaces of the above-mentioned film with a bar coater, (ii) drying, and then (iii) curing by irradiation of an ultraviolet light. Said curable coating was prepared by mixing 50 parts by weight of NK HARD M101 and 50 parts by weight of 1-methoxy-2-propanol (solvent), wherein the former contains a urethane acrylate-based curable compound as a main component, and is produced by Shin-Nakamura Chemical Co., Ltd. Here, NK HARD M101 is a solution containing (i) 80% by weight of a mixture of compounds having 3 to 6 acryloyloxy groups in their molecule, and (ii) a photo-radical initiator. The obtained film was evaluated according to the following methods, and results thereof are shown in Table 2.

(D) Evaluation

(D-1) Total Light Ray Transmittance (Tₜ, %) and Haze (%)

They were measured according to ASTM D 1003.

(D-2) Steel Wool Hardness Test

The generation of scratches on cured coatings was observed with eyes after 10-time reciprocation of steel wool No. 0000 with a load of 500 g/cm².

(D-3) Surface Resistance

It was measured according to JIS K 6911.

(D-3) Adhesiveness of a layer (peeling test)

It was measured according to a method prescribed in JIS K 5400, which comprises the steps of (i) cutting a sample film surface with a cutter such as a knife to make 100 square cuts, (ii) adhering an adhesive tape on said cuts, (iii) peeling off said adhesive tape, and then (iv) observing whether or not said square cuts have been peeled.

### Example 2

Example 1 was repeated except that the curable coating was replaced by a curable coating prepared by mixing 50 parts by weight of UNIDIC 17-806 produced by Dainippon Ink & Chemicals, Inc., and 50 parts by weight of 1-methoxy-2-propanol (solvent). Here, UNIDIC 17-806 is a solution containing (i) 80% by weight of a mixture of compounds having 5 acryloyloxy groups on an average in its molecule, and (ii) a photo-radical initiator. Results are shown in Table 2.

### Example 3

Example 1 was repeated except that the curable coating was replaced by NOPCOCURE 202, which is a blend of acrylate-based curable compounds, produced by San Nopco Ltd. Here, NOPCOCURE 202 is a solution containing (i) a compound having 3 acryloyloxy groups in its molecule and a compound having 6 acryloyloxy groups in its molecule in their total amount of 77% by weight, and (ii) a photo-radical initiator. Results are shown in Table 2.

### Example 4

Example 1 was repeated except that the curable coating was replaced by a curable coating prepared by mixing (i) 45 parts by weight of NK HARD M101-SM2 (IMPROVED) containing a urethane acrylate-based curable compound as a main component, produced by Shin-Nakamura Chemical Co., Ltd., (ii) 45 parts by weight of 1-methoxy-2-propanol (solvent), and (iii) 16 parts by weight of PC-14 produced by Catalysts & Chemicals Ind. Co., Ltd, which is a suspension containing 20% by weight of antimony pentoxide (electroconductive inorganic particle) having an average particle diameter of 0.02 μm. Here, a blending ratio of a curable compound to a photo-radical initiator contained in NK HARD M101-SM2 (IMPROVED) is the same as that in NK HARD M101 used in Example 1. Results are shown in Table 2.

### Comparative Example 1

Example 1 was repeated except that only the methacryl resin pellet mentioned in Example 1 (A) was used. Results are shown in Table 2.

TABLE 1

| | Result of impact test |
|---|---|
| Example 1 | No crack was observed |
| Comparative Example 1 | Cracks were observed |

TABLE 2

| | Example | | | | Comparative |
|---|---|---|---|---|---|
| | 2 | 3 | 4 | 5 | Example 1 |
| Tt (%) | 91.3 | 91.3 | 91.4 | 90.8 | 92.8 |
| Haze (%) | 0.3 | 0.3 | 0.3 | 0.6 | 0.4 |
| Steel wool | no | no | no | no scratch | many scratches |
| hardness test | scratch | scratch | scratch | | |
| Surface | ≧10¹⁵ | ≧10¹⁵ | ≧10¹⁵ | 6.0 × 10¹¹ | ≧10¹⁵ |
| resistance | Ω/□ | Ω/□ | Ω/□ | Ω/□ | Ω/□ |
| Peeling test | no | no | no | no peeling | — |
| | peeling | peeling | peeling | | |

1. A film, which comprises a methacryl resin layer containing a dispersed rubber particle, wherein at least one surface of said film has a cured layer containing a curable coating, and said film has thickness of 100 to 1800 μm.

2. The film according to claim 1, wherein the dispersed rubber particle contains a dispersed acryl rubber particle.

3. The film according to claim 1, wherein the dispersed rubber particle has an average particle diameter of 0.1 to 0.4 μm.

4. The film according to claim 1, wherein the film is a single layer film comprising only a methacryl resin layer containing a dispersed rubber particle.

5. The film according to claim 1, wherein the film comprises at least two layers, one layer of which is a methacryl resin layer containing a dispersed rubber particle, and another layer of which is a methacryl resin layer containing no rubber particle, and the former layer has thickness of 50 to 96% of a total thickness of the film.

6. The film according to claim 1, wherein the curable coating contains a compound having at least tree (meth) acryloyloxy groups in its molecule or an oligomer thereof.

7. The film according to claim 1, wherein the curable coating contains a compound having at least tree (meth) acryloyloxy groups in its molecule or an oligomer thereof, and a dispersed electroconductive inorganic particle.

8. A protecting sheet for a display window of a portable-type information terminal, which comprises a film according to claim 1.
